(19) United States
(12) Patent Application Publication
(10) Pub. No.: US 2010/0098422 A1
(43) Pub. Date: Apr. 22, 2010

(54) OPTICAL COMMUNICATION APPARATUS AND METHOD OF CONTROLLING SEMICONDUCTOR OPTICAL AMPLIFIER

(75) Inventor: Hidekazu TAKEDA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/556,847

(22) Filed: Sep. 10, 2009

(30) Foreign Application Priority Data
Oct. 17, 2008 (JP) 2008-268483

(51) Int. Cl. H04J 14/02

(52) U.S. Cl. 398/79

(57) ABSTRACT

An optical communication system and method thereof include outputting a wavelength division multiplexed (WDM) light to a transmission line, the WDM light being multiplexed from a plurality of signal lights, and one of the plurality of signal lights being converted from a pilot superimposed signal that has a data signal superimposed with a pilot signal and receiving the WDM light at a receiving station including a demultiplexer, a semiconductor optical amplifier, a photoelectric converter, a detection unit, and a controller. The plurality of signal lights are demultiplexed into a plurality of electric signals, respectively and the pilot signal is detected in the plurality of electric signals, with the exception of the pilot superimposed signal, and an amplification condition of the semiconductor optical amplifier is controlled based on the pilot signal detected.

### CROSS-REFERENCE TO RELATED APPLICATIONS

The application is based upon and claims the benefit of priority of the prior Japanese Patent Application No. 2008-268483, filed on Oct. 17, 2008, the entire contents of which are incorporated herein by reference.

### BACKGROUND

1. Field

The present invention relates to an optical communication apparatus and a method of controlling a semiconductor optical amplifier.

2. Description of the Related Art

In recent years, to increase the speed and capacity of networks, attention has been given to optical communication technology. In optical communication technology, information is transmitted not by electric signals but by signal lights, utilizing an optical fiber as a transmission line. For example, according to a 100-gigabit Ethernet (trademark) standard, communication of 100 Gbps is performed at 25.78125 Gbps×4 lights of different wavelengths. That is, the communication is performed by utilizing four lights of different wavelengths at a modulation speed of 25.78125 Gbps per channel.

According to the 100-gigabit Ethernet standard with a transmission speed of 40 km, a semiconductor optical amplifier is used as a preamplifier, and signal lights of four wavelengths are collectively amplified.

As a method of controlling the semiconductor optical amplifier, a technique is known that utilizes a pilot signal for the semiconductor optical amplifier in order to keep its gain constant. The technique is described, for example, in Electronics Letters No. 25, pp. 235-236, 1989. According to this technique, a transmission apparatus transmits a signal light to a reception apparatus, by superimposing a pilot signal to the signal light. The reception apparatus extracts the pilot signal from the signal light to which the pilot signal is superimposed. Then, the reception apparatus keeps a gain of the semiconductor optical amplifier within a certain range by utilizing the pilot signal, in order to avoid gain saturation in the semiconductor optical amplifier.

Another typical technique superimposes a pilot signal to a plurality of signal lights with different wavelengths, multiplexes the plurality of signal lights, and transmits the multiplexed signal light to the reception apparatus. The technique is described, for example, in JP-A-11-41208.

A semiconductor optical amplifier using the techniques above and others similar thereto cannot be used in the gain saturation region. Gain saturation occurs when high-power signal light is input to the semiconductor optical amplifier and the excitation carrier is reduced by a stimulated emission. As a result, the signal gain differs when the power of the input light differs and the gain saturation occurs.

For example, when the gain saturation region of the semiconductor optical amplifier changes due to age deterioration or the like, the semiconductor optical amplification performs an amplification using the changed gain saturation region, and a crosstalk between channels occurs and decreases reception sensitivity.

### SUMMARY

An optical communication system includes a transmission station configured to output a wavelength division multiplexed (WDM) light to a transmission line, where the WDM light is multiplexed from a plurality of signal lights, and one of the plurality of signal lights is converted from a pilot superimposed signal having a data signal superimposed with a pilot signal, and a receiving station configured to input the WDM light from the transmission line, the receiving station including a demultiplexer, a semiconductor optical amplifier, a photoelectric converter, a detection unit, and a controller.

The semiconductor optical amplifier has a gain saturation characteristic and amplifying the WDM light, where the demultiplexer is configured to demultiplex the WDM light amplified by the semiconductor optical amplifier into the plurality of signal lights, the photoelectric converter is configured to convert the plurality of signal lights demultiplexed by the demultiplexer into a plurality of electric signals, respectively, the detection unit is configured to detect the pilot signal in the plurality of electric signals, with the exception of the pilot superimposed signal, and the controller is configured to control an amplification condition of the semiconductor optical amplifier based on the pilot signal detected by the detection unit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a view illustrating a system configuration of an optical communication system;

FIG. 2 is a view illustrating a transmission apparatus of an embodiment;

FIG. 3 is a view illustrating a reception apparatus of an embodiment;

FIG. 4 is a view illustrating a semiconductor optical amplifier;

FIG. 5A is a view illustrating a gain saturation characteristic of a semiconductor optical amplifier;

FIG. 5B is a view illustrating a gain saturation characteristic of a semiconductor optical amplifier when an amount of injected current is increased;

FIG. 6 is a view illustrating another structure of a reception apparatus;

FIG. 7 is a flowchart illustrating a procedure of processing including by a control unit;

FIG. 8 is a view illustrating a transmission apparatus of an embodiment;

FIG. 9 is a view illustrating a reception apparatus of an embodiment;

FIG. 10 is a view illustrating a structure of a transmission apparatus of an embodiment, and illustrates a manner in which a light power of a light source is controlled by a transmission apparatus side control unit based on a notification from the control unit of a reception apparatus;

FIG. 11 is a view illustrating another structure of a transmission apparatus;

FIG. 12A illustrates an example in which an excitation light source is provided in a preceding stage of a semiconductor optical amplifier; and

FIG. 12B illustrates an example in which an excitation light source is provided in a succeeding stage of a semiconductor optical amplifier.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

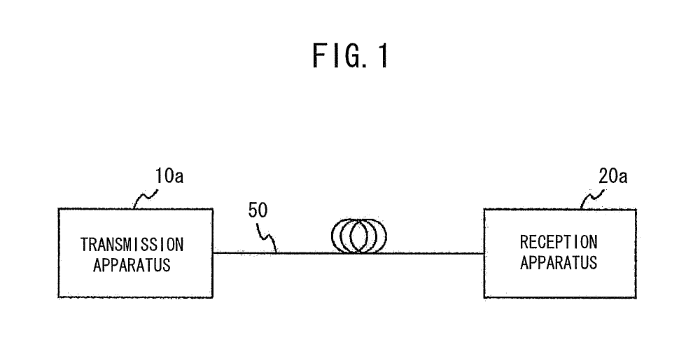

FIG. 1 is a view illustrating a system configuration of an optical communication system of an embodiment.

In FIG. 1, the optical communication system includes a transmission apparatus 10a, a reception apparatus 20a, and an optical transmission line 50, such as an optical fiber, that connects the transmission apparatus 10a and the reception apparatus 20a.

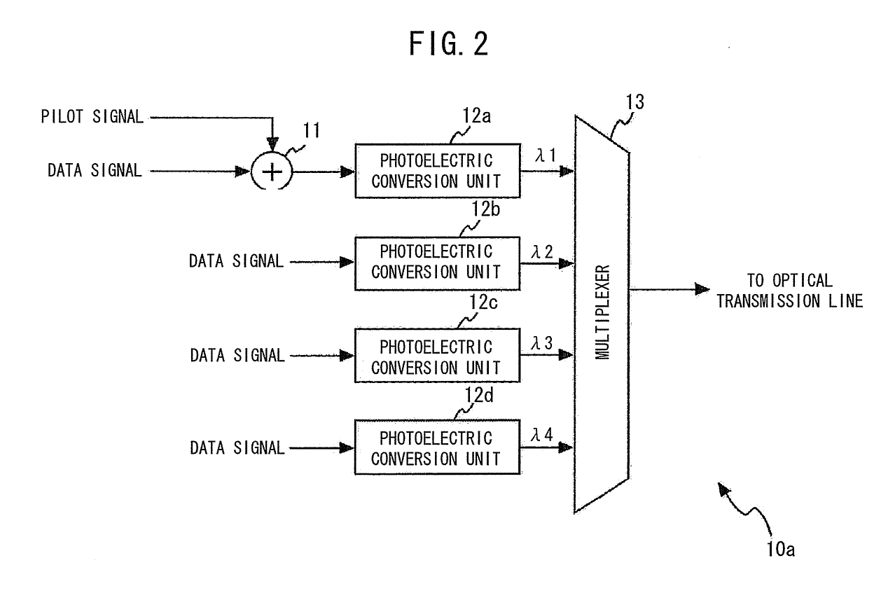

Next, FIG. 2 is a view illustrating a transmission apparatus of the transmission apparatus 10a. The transmission apparatus 10a has a superimposing unit 11, photoelectric conversion units 12a to 12d, and a multiplexer 13. The photoelectric conversion units 12a to 12d are provided, for example, for each communication channel.

While FIG. 1 illustrates a case where four channels are provided as communication channels, a number of communication channels is not limited to four. Hereinafter, a communication channel 1 is a communication channel that utilizes a signal light which is converted to an electric signal by the photoelectric conversion unit 12a. Likewise, communication channels 2, 3, and 4 are communication channels utilizing signal lights which are converted to electric signals by the photoelectric conversion units 12b, 12c and 12d, respectively. The conversion units 12 correspond to each wavelength of the signals that are to be converted.

A wavelength of λ1 is a wavelength of a signal light used for the communication channel 1, and a wavelength λ2 is a wavelength of the signal light used for communication by the communication channel 2. Likewise, a wavelength is a wavelength of the signal light used for the communication channel 3, and a wavelength of λ4 is a wavelength of the signal light used for the communication channel 4.

The superimposing unit 11 superimposes a pilot signal on a data signal, and outputs the superimposed signal to the photoelectric conversion unit 12a. The modulation wavelength of the data signal may be several GHz to several tens of GHz. The wavelength of the signal used as the pilot signal may be several hundreds of Hz to several thousands of kHz, and a wavelength sufficiently lower than the wavelength of the data signal is used. The output of the superimposing unit 11 is output to the photoelectric conversion unit 12a.

The photoelectric conversion unit 12a converts the data signal, on which the pilot signal is superimposed, into a signal light. The photoelectric conversion unit 12a outputs the converted signal light to the multiplexer 13.

Likewise, the photoelectric conversion units 12b to 12d convert the data signals of the channels 2 to 4 into signal lights, respectively, and output the converted signal lights to the multiplexer 13.

According to an embodiment, the multiplexer 13 has four ports inputting a plurality of lights with different wavelengths of λ1, λ2, λ3 and λ4, and multiplexes the signal lights. The multiplexed signal light (wavelength-division multiplexed signal light) is output to the optical transmission line 50 (FIG. 1), and input to the reception apparatus 20a.

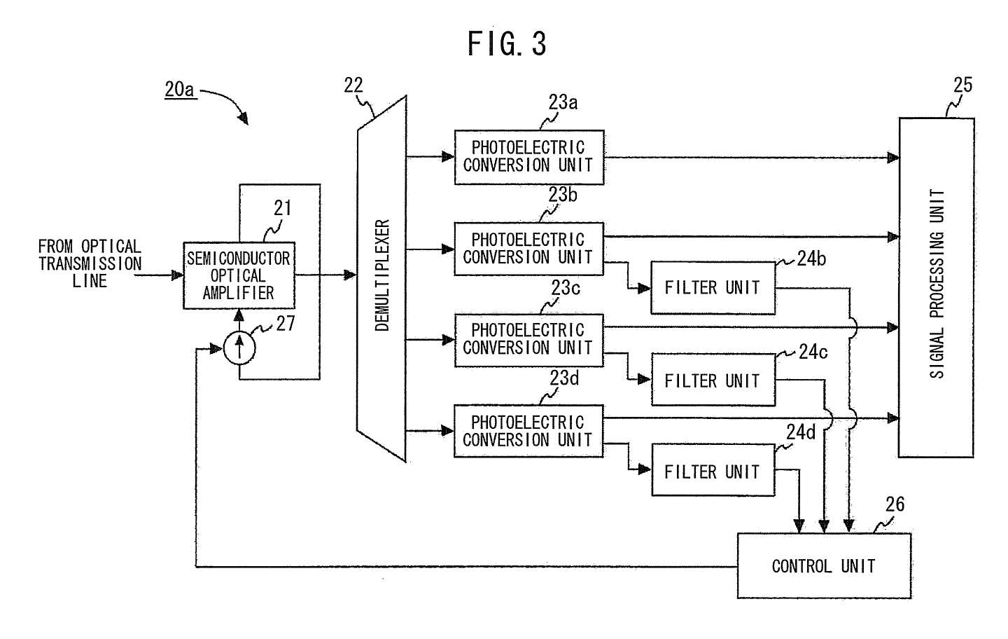

Next, FIG. 3 is a view illustrating the reception apparatus 20a. The reception apparatus 20a has a semiconductor optical amplifier 21, a demultiplexer 22, photoelectric conversion units 23a to 23d, filter units 24b to 24d, a signal processing unit 25 and a control unit 26.

The signal light received through the optical transmission line 50 is input to the semiconductor optical amplifier 21. The semiconductor optical amplifier 21 amplifies the input signal light and outputs to the demultiplexer 22.

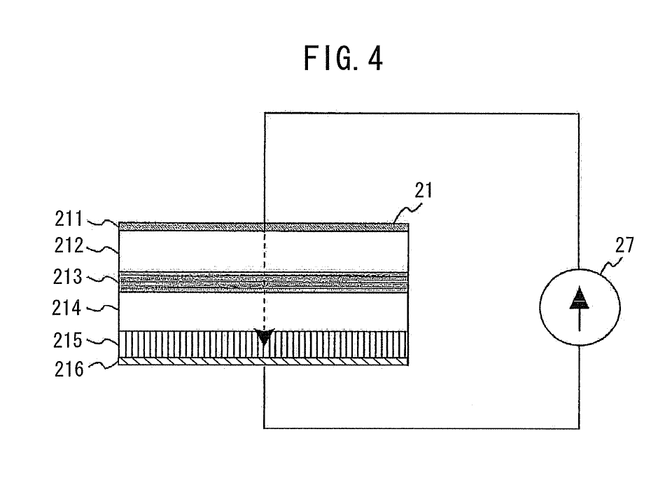

FIG. 4 is a view illustrating the semiconductor optical amplifier 21. The semiconductor optical amplifier 21 is an amplifier having a gain saturation characteristic. The semiconductor optical amplifier 21 has, for example, an active layer 213 made of a semiconductor, a p-type semiconductor layer 212, an n-type semiconductor layer 214, a substrate 215, and electrodes 211 and 216 for current injection. The p-type semiconductor layer 212 and the n-type semiconductor layer 214 are disposed so as to sandwich the active layer 213

In a case when no current is injected from a current source 27 (OFF), and when light is incident on the active layer 213, electrons in the valence band absorbs the light, and the electrons themselves make a transition to the conduction band (absorption).

When there are electrons in the conduction band and light having energy corresponding to the band gap passes near the electrons, the electrons make a transition from the conduction band to the valence band and, at the same time, emits light whose wavelength, phase, and direction are the same as those of the input light (stimulated emission).

In the semiconductor optical amplifier 21, by forming a p-n junction and creating an inverted distribution, where the carrier density is high, by current injection (ON), amplification (stimulated-emission) of the incident light, such as WDM light, is realized.

The demultiplexer 22 demultiplexes the signal light (WDM light) amplified by the semiconductor optical amplifier 21, to signal lights of the different wavelengths (λ1, λ2, λ3 and λ4). The signal lights demultiplexed by the demultiplexer 22 are output to the photoelectric conversion units 23a to 23d, respectively.

The photoelectric conversion units 23a to 23d are provided for the communication channels, respectively, and convert the signal lights of the corresponding communication channels into electric signals. The data signal converted into an electric signal by the photoelectric conversion unit 23a is output to the signal processing unit 25. The data signals converted into electric signals by the photoelectric conversion units 23b to 23d are output to the signal processing unit 25 and output to the filter units 24b to 24d, respectively.

The signal processing unit 25 receives the data signals output from the photoelectric conversion units 23a to 23d, and demodulates the signals to thereby obtain binary format data. Then, the signal processing unit 25 performs processing set for each communication channel.

The filter units 24b to 24d perform filtering processing on the data signals, which are converted into electric signals by the photoelectric conversion units 23b to 23d, thereby extracting the pilot signals contained in the data signals. The extracted pilot signals are output to the control unit 26.

The control unit 26 calculates an average power of each of the pilot signals detected on the communication channels 2 to 4, and controls the semiconductor optical amplifier 21 based on the calculated average power. For example, when pilot signals are detected by the filter units 24b to 24d, the control unit 26 adds the signal powers of the pilot signals for each of the communication channels 2 to 4, and divides the sum by the number of pilot signals whose signal powers are added, thereby obtaining the average power of the pilot signals for each communication channel.

The transmission apparatus 10a superimposes a pilot signal on the data signal of the communication channel 1, and transmits the superimposed signal to the reception apparatus 20a. The reception apparatus 20a receives the signal light containing the pilot signal through the optical transmission path 50, and inputs it to the semiconductor optical amplifier 21.

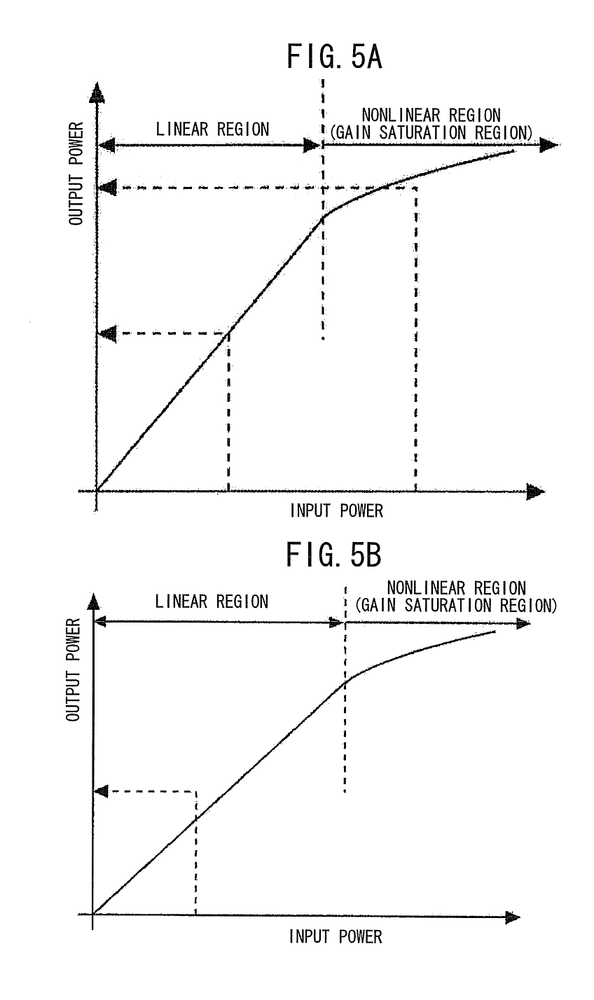

FIG. 5A is a view illustrating a gain saturation characteristic of a semiconductor optical amplifier. The semiconductor optical amplifier 21 has a gain saturation characteristic. As illustrated in FIG. 5A, the semiconductor optical amplifier 21 has a region where the amplification characteristic exhibits linearity (hereinafter, referred to as linear region) and a region where the amplification characteristic does not exhibit linearity (hereinafter, referred to as nonlinear region, or gain saturation region). When the input light power of the signal light is in the linear region, the signal light is amplified and output with a gain corresponding to the input light power. When the input light power of the signal light is in the nonlinear region, the gain is reduced when the input light power becomes equal to or more than a given extent, and the signal gain do not correspond to the power of the input light.

When the power of the input light input to the semiconductor optical amplifier 21 is in the linear region, the semiconductor optical amplifier 21 amplifies the signal light with a gain corresponding to the input light power, and outputs the amplified output light to the demultiplexer 22. However, when the power of the input light input to the semiconductor optical amplifier 21 is in the nonlinear region (gain saturation region), the gain of the semiconductor optical amplifier 21 is reduced. When the range of the linear region of the semiconductor optical amplifier 21 is decreased, due to age deterioration or the like, for example, there are cases where the power of the input light input to the semiconductor optical amplifier 21 is in the nonlinear region.

When the input light in the nonlinear area of the semiconductor optical amplifier 21 is amplified, the component of the pilot signal is superimposed in polarity-inverted state on the signal light of another communication channel by cross-gain modulation.

Accordingly, in an embodiment, the pilot signal(s) superimposed on the data signals of the communication channels 2 to 4 are detected by the filter units 24b to 24d provided on the communication channels 2 to 4. The control unit 26 calculates the average power of the detected pilot signals for each of the channels 2 to 4. Then, the control unit 26 compares the average power of the pilot signals calculated for each of the channels 2 to 4 with a threshold value. When the average power of a communication channel is detected to be higher than the threshold value, the control unit 26 controls the saturation output power of the semiconductor optical amplifier 21 or controls the power of the input light of the semiconductor optical amplifier 21. By the control, the amplification of the signal light is controlled so as to be performed in the region of the input power where the amplification characteristic of the semiconductor optical amplifier 21 exhibits linearity.

FIG. 5B is a view illustrating the gain saturation characteristic of the semiconductor optical amplifier when an amount of injected current is increased. To enhance the saturation output power of the semiconductor optical amplifier 21 (that is, to expand the linear region), the current source 27 is controlled so that the amount of injected current supplied to the semiconductor optical amplifier 21 is increased. The control unit 26 controls the amount of injected current according to a difference between the average power of the pilot signals and the threshold value. As illustrated in FIG. 5B, the gain saturation characteristic of the semiconductor optical amplifier 21 changes when the injected current is increased. As is apparent when FIGS. 5A and 5B are compared with each other, by increasing the amount of injected current supplied to the semiconductor optical amplifier 21, the region of the input power where the amplification characteristic of the semiconductor optical amplifier 21 exhibits linearity can be expanded.

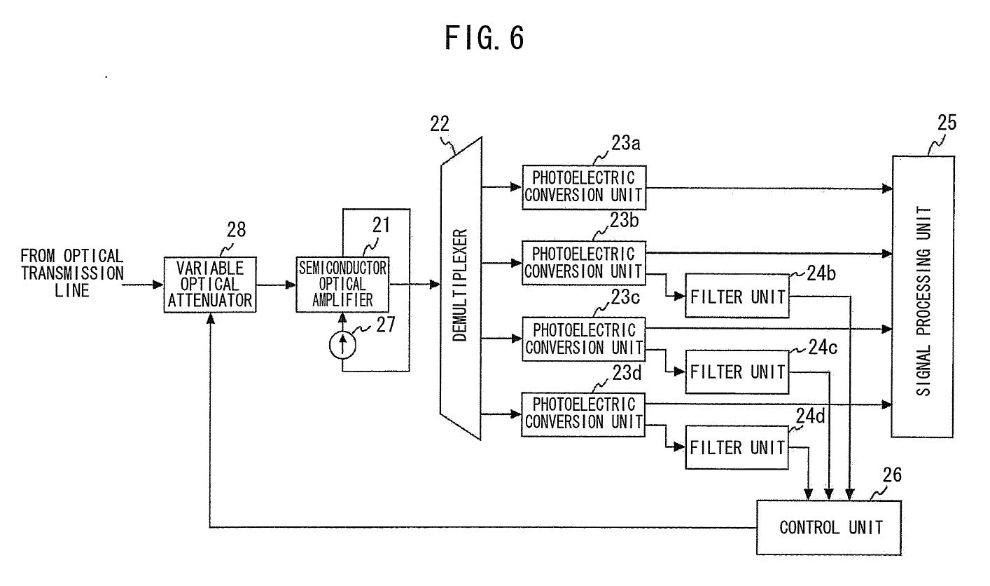

FIG. 6 is a view illustrating another structure of the reception apparatus. The control unit 26 may perform control so that the input light power of the semiconductor optical amplifier 21 is restricted.

As illustrated in FIG. 6, a variable optical attenuator 28 is provided in a preceding stage of the semiconductor optical amplifier 21. The control unit 26 outputs the signal light to the semiconductor optical amplifier 21 after attenuating the light power of the signal light by the variable optical attenuator 28 based on a difference between the average power of the pilot signals and the threshold value. Consequently, the input light power of the semiconductor optical amplifier 21 is weakened, and only the region of the input light power where the amplification characteristic of the semiconductor optical amplifier 21 exhibits linearity can be used for amplification.

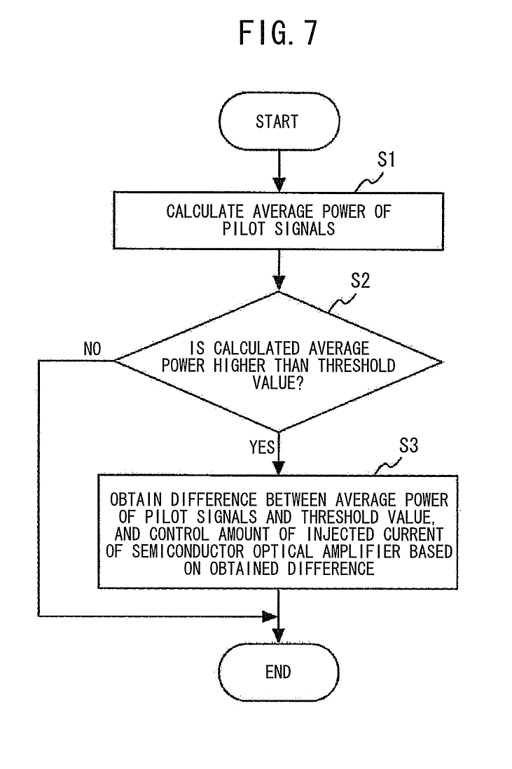

FIG. 7 is a flowchart illustrating a procedure of processing, for example, by a control unit 26. As illustrated in FIG. 7, when optical communication between the transmission apparatus 10a and the reception apparatus 20a is started, the filter units 24b to 24d of the reception apparatus 20a detect the pilot signals from the electric signals of the communication channels 2 to 4, respectively. The detected pilot signals are output from the filter units 24b to 24d to the control unit 26. The control unit 26 calculates the average power of the pilot signals obtained from the filter units 24b to 24d for each of the channels 2 to 4. For example, every time a pilot signal is input from the filter units 24b to 24d, the signal power of the input pilot signal is added, and the average value of the signal power is obtained for each communication channel (operation S1). Then, the control unit 26 compares the calculated average power of the pilot signals with the threshold value (operation S2). The control unit 26 compares the average power of the pilot signals calculated for each communication channel with the threshold value, and determines whether or not there is a communication channel where the average power is higher than the threshold value (operation S2). When the average power of the pilot signals in a communication channel is detected to be higher than the threshold value (operation S2/YES), the control unit 26 obtains the difference between the average power of the pilot signals and the threshold value. Then, the control unit 26 controls the current source 27 based on the obtained difference, thereby increasing the amount of current supplied to the semiconductor optical amplifier 21 (operation S3).

When the components of the pilot signals are superimposed on the data signals of the communication channels 2 to 4, it can be determined whether the semiconductor optical amplifier 21 amplifies the input light by using the saturation region. Therefore, the control unit 26 increases the amount of current supplied to the semiconductor optical amplifier 21 to thereby expand the linear region where the amplification characteristic of the semiconductor optical amplifier 21 exhibits linearity.

As described above, according to an embodiment, the pilot signals, which are contained in the data signals of the communication channels other than the data signal on which the pilot signal is superimposed by the transmission apparatus 10a, are detected by the reception apparatus. When the average power of the detected pilot signals is equal to or higher than the threshold value, it is determined that amplification using the gain saturation region of the semiconductor optical amplifier 21 is performed, and an operation range of the input light power of the semiconductor optical amplifier 21 is increased. Consequently, even if the gain saturation region of the semiconductor optical amplifier 21 is changed, due to age deterioration or the like, for example, the semiconductor optical amplifier 21 can be controlled so that no gain saturation occurs.

Moreover, since the injected current supplied to the semiconductor optical amplifier 21 is controlled to thereby increase the operation range of the input light power of the semiconductor optical amplifier 21, the control of the semiconductor optical amplifier 21 is facilitated. Moreover, by providing the variable optical attenuator 28 (FIG. 6) in the preceding stage of the semiconductor optical amplifier 21, the signal light can be input to the semiconductor optical amplifier 21 after the power of the signal light is attenuated by the variable optical attenuator 28. Consequently, the signal light can be amplified by using only the region where the amplification characteristic of the semiconductor optical amplifier 21 exhibits linearity.

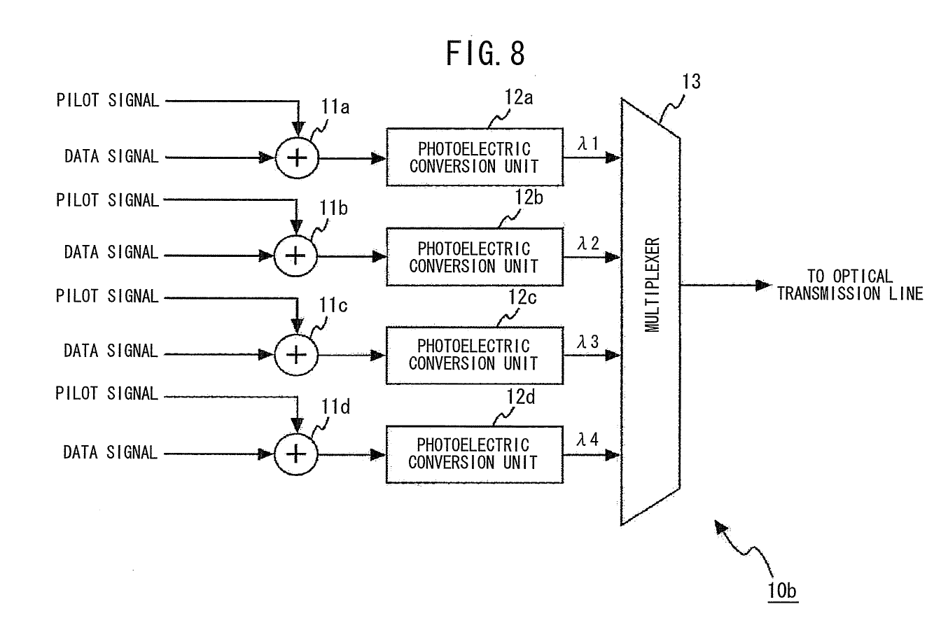

FIG. 8 is a view illustrating a transmission apparatus of an embodiment. With respect to this embodiment, descriptions of parts similar to those of the above-described embodiment are omitted.

As illustrated in FIG. 8, the transmission apparatus 10b of an embodiment superimposes the pilot signal on the data signals of all of the communication channels 1 to 4. The superimposing unit 11, which is provided only for the communication channel 1 in the above-described embodiment, is also provided for each of the communication channels 2 to 4. The frequencies of the pilot signals superimposed on the data signals of the communication channels are different from one another. For example, as the frequency of the pilot signal superimposed on the data signal of the communication channel 1, 700 Hz is used (the pilot signal of the frequency is referred as f1). As the frequency of the pilot signal superimposed on the data signal of the communication channel 2, 1300 Hz is used (the pilot signal of the frequency is referred as f2). As the frequency of the pilot signal superimposed on the data signal of the communication channel 3, 1900 Hz is used (the pilot signal of the frequency is referred as f3). As the frequency of the pilot signal superimposed on the data signal of the communication channel 4, 2500 Hz is used (the pilot signal of the frequency is referred as f4).

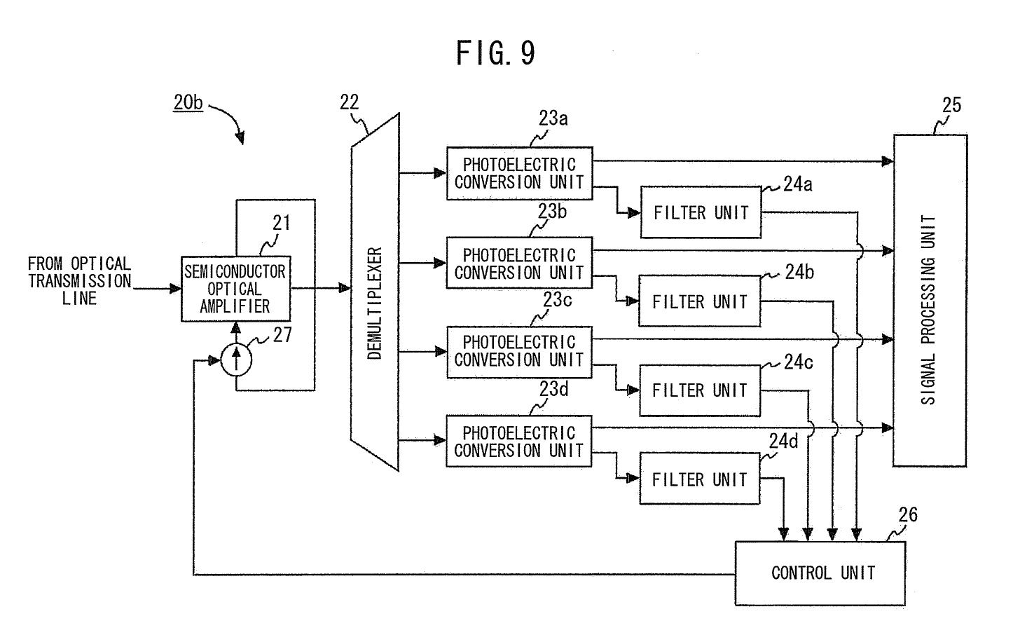

FIG. 9 is a view illustrating a reception apparatus 20b of an embodiment. As illustrated in FIG. 9, a filter unit 24a is also provided for the communication channel 1.

The filter unit 24a detects the frequency components of the pilot signals (f2, f3 and f4) superimposed on the data signals of the communication channels 2 to 4, from the data signal of the communication channel 1. The detected pilot signals of the frequencies (f2, f3 and f4) are output from the filter unit 24a to the control unit 26. The filter unit 24b detects the frequency components of the pilot signals (that is, f1, f3 and f4) superimposed on the data signals of the communication channels 1, 3 and 4, from the data signal of the communication channel 2. The detected pilot signals of the frequencies (f1, f3 and f4) are output from the filter unit 24b to the control unit 26. The filter unit 24c detects the frequency components of the pilot signals (f1, f2 and f4) superimposed on the data signals of the communication channels 1, 2 and 4, from the data signal of the communication channel 3. The detected pilot signals of the frequencies (f1, f2 and f4) are output from the filter unit 24c to the control unit 26. The filter unit 24d detects the frequency components of the pilot signals (f1, f2 and f3) superimposed on the data signals of the communication channels 1 to 3, from the data signal of the communication channel 4. The detected pilot signals of the frequencies (f1, f2 and f3) are output from the filter unit 24a to the control unit 26.

Based on the pilot signals obtained from the filter units 24a to 24d, the control unit 26 identifies the communication channel that causes the power of the light input to the semiconductor optical amplifier 21 to be in the nonlinear region (gain saturation region) of the semiconductor optical amplifier 21.

First, the control unit 26 obtains the average power of the pilot signals detected by each of the filter units 24a to 24d.

From the pilot signals detected by the filter unit 24a, the average power of the pilot signals of the frequencies f2, f3 and f4 is obtained. Likewise, from the pilot signals detected by the filter unit 24b, the average power of the pilot signals of the frequencies f1, f3 and f4 is obtained, and from the pilot signals detected by the filter unit 24c, the average power of the pilot signals of the frequencies f1, f2 and f4 is obtained. Moreover, from the pilot signals detected by the filter unit 24d, the average power of the pilot signals of the frequencies f1, f2 and f3 is obtained.

The control unit 26 compares the calculated average powers of the pilot signals of the frequencies f1, f2, f3 and f4, and determines the communication channel the signal light of which causes the input light power to be in the nonlinear region (gain saturation region) of the semiconductor optical amplifier 21.

That is, when the average power of the pilot signal of the frequency f1 is higher than the threshold value, it can be determined that the light power of the communication channel 1 is high. Likewise, when the average power of the pilot signal of the frequency f2 is higher than the threshold value, it can be determined that the light power of the communication channel 2 is high.

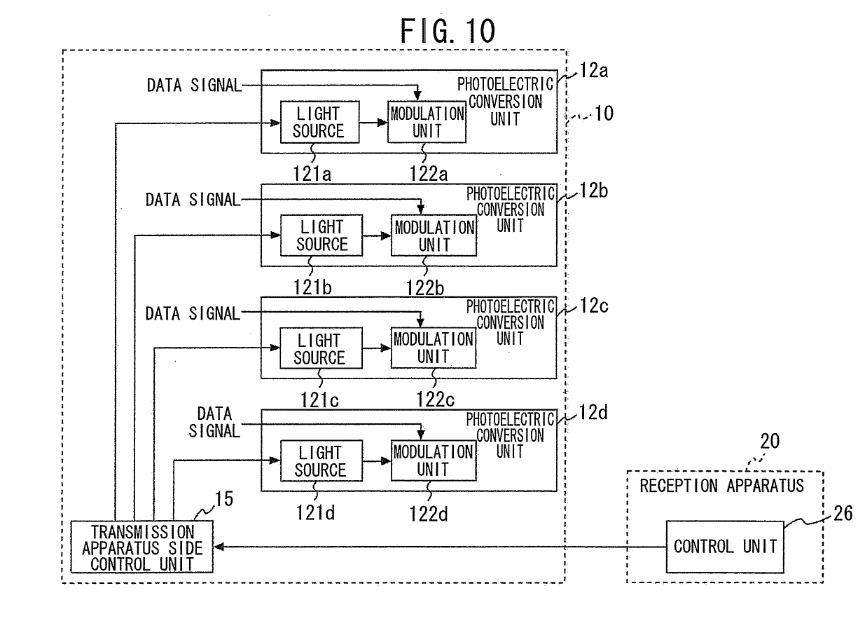

When identifying the communication channel with high light power, the control unit 26 of the reception apparatus 20b calculates the difference between the average power of the pilot signal superimposed on the data signal of the identified communication channel and the threshold value. The control unit 26 notifies a transmission apparatus side control unit 15 shown in FIG. 10 of the calculated difference between the average power of the pilot signal and the threshold value.

FIG. 10 is a view illustrating a structure of a transmission apparatus of an embodiment, and illustrates a manner in which the light power of the light source is controlled by a transmission apparatus side control unit based on a notification from the control unit of the reception apparatus. As illustrated in FIG. 10, the photoelectric conversion unit 12a of the transmission apparatus 10b has a light source 121a and a modulation unit 122a. Likewise, the photoelectric conversion unit 12b has a light source 121b and a modulation unit 122b, the photoelectric conversion unit 12c has a light source 121c and a modulation unit 122c, and the photoelectric conversion unit 12d has a light source 121d and a modulation unit 122d.

When notified of the communication channel with high light power and the difference between the average power of the pilot signal and the threshold value by the control unit 26 on the side of the reception apparatus 20b, the transmission apparatus side control unit 15 controls the light power of the light source of the communication channel concerned. That is, the light source 121a, 121b, 121c or 121d of the communication channel with high optical power is reduced according to the difference between the average power of the pilot signal and the threshold value.

As described above, according to the present embodiments, when the input light power is in the region of the input light power where the amplification characteristic of the semiconductor optical amplifier 21 does not exhibit linearity, the communication channel using the signal light that increases the input light power is identified. Consequently, by reducing the light power of the signal light of the identified communication channel, the signal light can be amplified by using only the region where the amplification characteristic of the semiconductor optical amplifier 21 exhibits linearity.

In the above-described embodiment, to increase the saturation output power of the semiconductor optical amplifier 21 (that is, to expand the linear region), the amount of injected current supplied to the semiconductor optical amplifier 21 is controlled.

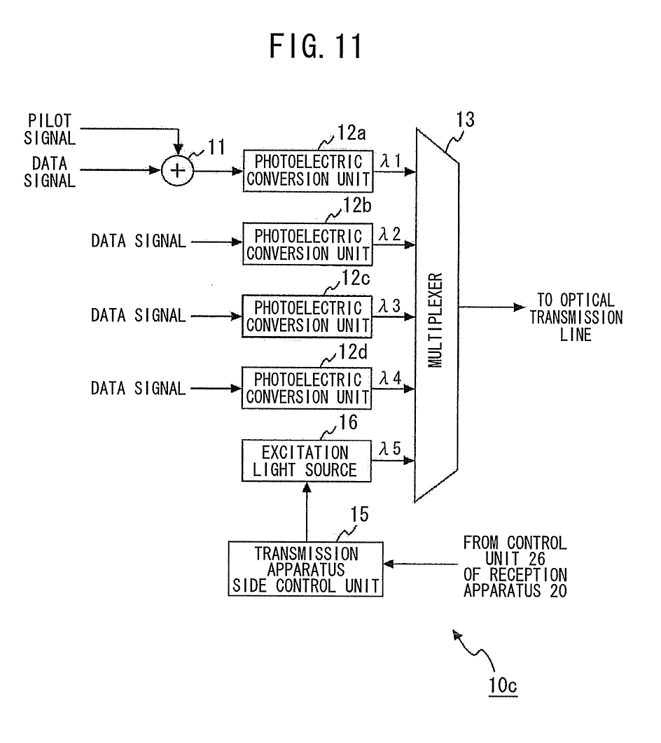

FIG. 11 is a view illustrating another structure of a transmission apparatus. As illustrated in FIG. 11, when detecting that the average power of the pilot signal detected on any of the communication channels 2 to 4 exceeds the threshold value, the control unit 26 notifies a transmission apparatus 10c of the difference between the average power of the pilot signal and the threshold value. The transmission apparatus 10c side has the transmission apparatus side control unit 15 and an excitation light source 16. The transmission apparatus side control unit 15 controls the excitation light source 16 according to the difference notified by the control unit 26 of the reception apparatus 20a side, and controls the input light power of the excitation light source input to the semiconductor optical amplifier 21 through the optical transmission line 50. That is, by increasing the light power of the excitation light output to the semiconductor optical amplifier 21 together with the signal light, the saturation output power of the semiconductor optical amplifier 21 can be increased.

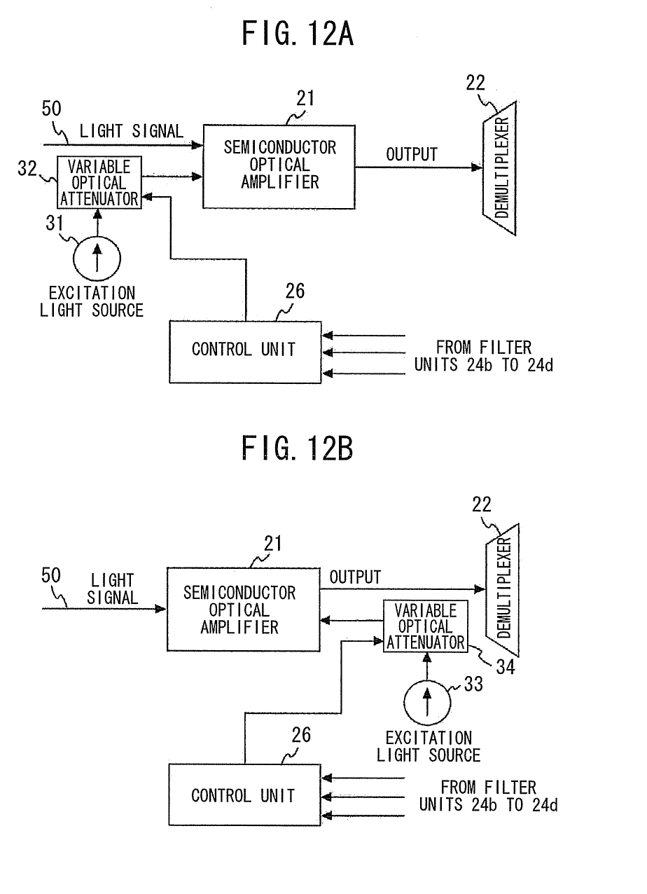

The excitation light source may be provided in the preceding or succeeding stage of the semiconductor optical amplifier 21. FIG. 12A illustrates an example in which an excitation light source 31 and a variable optical attenuator 32 are provided on the preceding side of the semiconductor optical amplifier 21. FIG. 12B illustrates an example in which an excitation light source 33 and a variable optical attenuator 34 are provided on the succeeding side of the semiconductor optical amplifier 21.

From the excitation light source 31 (or 33), the excitation light input to the active layer 213 of the semiconductor optical amplifier 21 is always output. The control unit 26 controls the variable optical attenuator 32 to thereby control the power of the excitation light input to the active layer 213 of the semiconductor optical amplifier 21. That is, to increase the saturation output power of the semiconductor optical amplifier 21, the control unit 26 reduces the excitation light of the excitation light source 31 (or 33) attenuated by the variable optical attenuator 32 (or 34).

As described above, according to the optical communication apparatus of the embodiments, the semiconductor optical amplifier can be controlled so that no gain saturation occurs in the semiconductor optical amplifier.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention, the scope of which is defined in the claims and their equivalents.

What is claimed is:

1. An optical communication system, comprising:
a transmission station configured to output a wavelength division multiplexed (WDM) light to a transmission line, the WDM light being multiplexed from a plurality of signal lights, and one of the plurality of signal lights being converted from a pilot superimposed signal having a data signal superimposed to a pilot signal; and
a receiving station configured to input the WDM light from the transmission line, the receiving station including a demultiplexer, a semiconductor optical amplifier, a photoelectric converter, a detection unit, and a controller; and
wherein the semiconductor optical amplifier has a gain saturation characteristic and amplifying the WDM light,
the demultiplexer is configured to demultiplex the WDM light amplified by the semiconductor optical amplifier into the plurality of signal lights,
the photoelectric converter is configured to convert the plurality of signal lights demultiplexed by the demultiplexer into a plurality of electric signals, respectively,
the detection unit is configured to detect the pilot signal in the plurality of electric signals, except the pilot superimposed signal, and
the controller is configured to control an amplification condition of the semiconductor optical amplifier based on the pilot signal detected by the detection unit.

2. The optical communication system according to claim 1, wherein, the controller controls the amplification condition of the semiconductor optical amplifier by controlling a saturation output power of the semiconductor optical amplifier.

3. The optical communication system according to claim 2, wherein the controller controls the saturation output power of the semiconductor optical amplifier by controlling an injected current supplied to the semiconductor optical amplifier by controlling a current source.

4. The optical communication system according to claim 2, wherein the controller controls the saturation output power of the semiconductor optical amplifier by controlling power of excitation light supplied to the semiconductor optical amplifier by controlling an excitation light source.

5. The optical communication system according to claim 1, wherein, the controller controls the amplification condition of the semiconductor optical amplifier by controlling an input light power of the semiconductor optical amplifier.

6. The optical communication system according to claim 5, comprising:
an attenuation unit that attenuates the WDM light that is input from the optical transmission line and output to the semiconductor optical amplifier, and
wherein the controller controls the input light power of the semiconductor optical amplifier by controlling an attenuation amount of the attenuation unit.

7. The optical communication system according to claim 1, wherein,
the controller calculates an average power of the pilot signal detected by the detection unit, and
the controller controls amplification of the semiconductor optical amplifier when the calculated average power becomes equal to or higher than a determination threshold value.

8. A method, comprising:
multiplexing a plurality of signal lights into a wavelength division multiplexed (WDM) light, one of the plurality of signal lights being converted from a pilot superimposed signal having a data signal superimposed with a pilot signal;
transmitting the WDM light through an optical transmission line;
receiving the WDM light from the optical transmission line;
amplifying the WDM light by a semiconductor optical amplifier, the semiconductor optical amplifier having a gain saturation characteristic;
demultiplexing the WDM light amplified by the semiconductor optical amplifier into the plurality of signal lights;
converting the demultiplexed plurality of signal lights into a plurality of electric signals, respectively;
detecting the pilot signal in the plurality of electric signals, except the pilot superimposed signal; and
controlling an amplification condition of the semiconductor optical amplifier based on the detected pilot signal.

9. A computer implemented method of controlling a semiconductor optical amplifier, comprising:
determining whether an average power of pilot signals calculated for each channel is higher than a threshold value; and
compensating for a gain saturation characteristic of said amplifier by controlling one of a saturation output power of said amplifier or a power of an input light to said amplifier based on a result of the determining.
